(19) United States
(12) Patent Application Publication
(10) Pub. No.: US 2012/0276439 A1
(43) Pub. Date: Nov. 1, 2012

(54) LITHIUM ION SECONDARY BATTERY

(75) Inventors: Takayuki Fujita, Niigata (JP); Hiroshi Sato, Niigata (JP)

(73) Assignee: NAMICS CORPORATION, Niigata (JP)

(21) Appl. No.: 13/517,171

(22) PCT Filed: Dec. 9, 2010
(86) PCT No.: PCT/JP2010/072168

§ 371 Date: Jul. 20, 2012

(30) Foreign Application Priority Data
Dec. 21, 2009 (JP) 2009-289571

(51) Int. Cl. H01M 10/0562; H01M 10/02; H01M 4/131

(52) U.S. Cl. 429/149; 429/209; 429/224; 429/231.1; 429/231.2; 429/322

(57) ABSTRACT

It is difficult to display the polarity of terminal electrodes of lithium ion batteries. With conventional lithium ion secondary batteries, since different materials are employed for the active substances that make up a positive electrode and a negative electrode, problems arise if the polarities of the electrodes are mistaken when the battery is installed. A battery has been developed using an active substance material functioning as a secondary battery even when the same material is used for the active substances that make up the positive electrode and the negative electrode, and a non-polar secondary battery has been produced. With no distinction between the terminal electrodes, attention does not need to be paid to the direction of installation, thereby simplifying the installation step. Furthermore, since there is no need to manufacture a positive electrode layer and a negative electrode layer separately, the step for manufacturing the battery is also simplified.

### TECHNICAL FIELD

This invention relates to a lithium ion secondary battery in which electrode layers are alternately layered on each other while interposed by a solid or liquid electrolyte region.

### BACKGROUND ART

Patent Document 1 WO/2008/099508

Patent Document 2 JP-A-2007-258165

Patent Document 3 JP-A-2008-235260

Patent Document 4 JP-A-2009-211965

In accordance with recent outstanding advances of electronic technology, endeavors have been made to reduce the weight, size and thickness of portable electronic devices and to multi-functionalize such portable electronic devices. In the course of such endeavors, there have been demands for reduction in size, weight and thickness of batteries as the power sources for such electronic devices and for enhancement of reliability of such batteries. In order to meet such demands, a multi-layered lithium ion secondary battery in which a plurality of positive electrode layers and a plurality of negative electrode layers are layered on one another while interposed by solid electrolyte layers has been proposed. Such multi-layered lithium ion secondary battery is assembled by layering several-ten-μm thick battery cells on one another, and thus capable of easily reducing its size, weight and thickness. Specifically, parallel or series parallel laminate batteries are excellent in that even a small cell area is able to provide a greater battery discharging capacity. On the other hand, an all-solid lithium ion secondary battery in which solid electrolyte is used in place of electrolyte solution is a highly reliable battery because risks of liquid leak and liquid depletion are suppressed. Further, such all-solid lithium ion secondary battery uses lithium, and thus provides a high voltage and a high energy density.

FIG. 9 is a cross-sectional view depicting a known lithium ion secondary battery (Patent Document 1). The known lithium ion secondary battery includes: a laminate in which a positive electrode layer 101, a solid electrolyte layer 102 and a negative electrode layer 103 are sequentially layered on one another; and terminal electrodes 104 and 105 to which the positive electrode layer 101 and the negative electrode layer 103 are electrically connected. While FIG. 9 depicts a battery including a single laminate for simplification and convenience, a battery in actual use is typically structured such that a plurality of positive electrode layers, a plurality of solid electrolyte layers and a plurality of negative electrode layers are sequentially layered on one another, in order to provide a high battery capacity. The positive electrode layer and the negative electrode layer respectively use different active substances. A substance with a rather noble redox potential is used as a positive electrode active substance while a substance with a rather base redox potential is used as a negative electrode active substance. According to the thus-structured battery, when a reference voltage is set at the terminal electrode of the negative electrode, the battery is charged by applying positive voltage on the terminal electrode of the positive electrode. When discharging the battery, the terminal electrode of the positive electrode outputs positive voltage. On the other hand, if, due to a mistake in the polarity of the terminal electrode, the reference voltage is set at the terminal electrode of the positive electrode and the positive voltage is applied on the terminal electrode of the negative electrode, the battery is not charged.

On the other hand, when using a secondary battery with a liquid electrolyte, guidelines with respect to discharging lower limit voltage, charging upper limit voltage, use temperature range and the like need to be strictly followed, for safely conducting the battery charging. Otherwise, the electrode metals may be eluted into the electrolyte, and the deposited metal may break through a separator. There is a danger that the battery may be short-circuit with the detached metal floating in the liquid electrolyte, thereby generating heat or causing damaged. It is quite dangerous to reversely charge a polar lithium ion secondary battery in which a liquid electrolyte is used, and such operation is tantamount to charging a battery with a voltage that falls below the discharging lower limit voltage.

For these reasons, in the practice to date, no matter whether a battery is sized small or large or whether a battery is an all-solid battery or a battery using a liquid electrolyte, all batteries have indicated the polarities on their surfaces. In addition, at the time of mounting a battery, the battery has been mounted so that its polarities are correctly positioned, by attending to the distinction between the polarities. However, specifically when a battery is sized to be as small as 5 mm or less on a side, whose manufacturing budget per unit is small, the manufacturing cost associated with these processes has been a prominently high impact.

Besides the manufacturing cost, as down-sizing of lithium ion secondary batteries is advanced further and further, all-solid small batteries manufactured by bulk baking (e.g., the batteries disclosed in Patent Document 1), in particular, are becoming technically difficult to a remarkable degree to carry marks on their surfaces for indicating the distinction between the positive electrodes and the negative electrodes.

In addition, secondary batteries that are in use mounted on to electronic circuit substrates (e.g., chip lithium ion secondary battery) are not easily detachable for correctly reattaching, even when such battery is mistakenly attached with the polarity wrongly positioned.

### DISCLOSURE OF THE INVENTION

### Problems to be Solved by the Invention

This invention serves to simplify a manufacturing process of a lithium ion secondary battery and to reduce a manufacturing cost thereof.

### Solutions to the Problems

According to an aspect (1) of the invention, a lithium ion secondary battery includes a first electrode layer and a second electrode layer, and the first electrode layer and the second electrode layer are alternately layered on each other while interposed by an electrolyte region. In the lithium ion secondary battery, the first electrode layer and the second electrode layer are formed to contain the same active substance, and the active substance concurrently has capabilities of both discharging lithium ion and absorbing lithium ion, the active substance having a spinel crystal structure.

According to an aspect (2) of the invention, in the lithium ion secondary battery according to the above aspect (1), the active substance may be a transition metal composite oxide, and a transition metal in the transition metal composite oxide may be adapted to change a valence.

According to an aspect (3) of the invention, in the lithium ion secondary battery according to the above aspect (1) or (2), the active substance may be a substance containing at least Mn.

According to an aspect (4) of the invention, in the lithium ion secondary battery according to any one of the above aspects (1) to (3), the active substance may be LiMn₂O₄ or LiV₂O₄.

According to an aspect (5) of the invention, in the lithium ion secondary battery according to any one of the above aspects (1) to (4), a substance forming the electrolyte region may be an inorganic solid electrolyte.

According to an aspect (6) of the invention, in the lithium ion secondary battery according to the above aspect (5), the substance forming the electrolyte region may be a ceramic containing at least lithium, phosphorus and silicon.

According to an aspect (7) of the invention, the lithium ion secondary battery according to any one of the above aspects (1) to (6) may be provided by baking a laminate in which the first electrode layer and the second electrode layer are layered on each other while interposed by the electrolyte region.

According to an aspect (8) of the invention, in the lithium ion secondary battery according to any one of the above aspects (1) to (4), a substance forming the electrolyte region may be a liquid electrolyte.

According to an aspect (9) of the invention, the lithium ion secondary battery according to any one of the above aspects (1) to (8) may be a series or series parallel battery in which a conductive layer is disposed between abutting battery cells.

According to an aspect (10) of the invention, an electronic device includes a power source, and the power source is the lithium ion secondary battery according to any one of the above aspects (1) to (9).

According to an aspect (11) of the invention, an electronic device includes a capacitor device, and the capacitor device is the lithium ion secondary battery according to any one of the above aspects (1) to (9).

### Effects of the Invention

According to the above aspects (1) to (7) of the invention, a non-polar lithium ion battery is realized. Thus, without attending to the distinction between the terminal electrodes, the manufacturing process and the mounting process of the battery maybe simplified, and the manufacturing cost thereof is reduced. Specifically, since the process of distinguishing the polarity is dispensable, a prominent advantageous effect is brought to the reduction in the manufacturing cost of batteries whose length, width and height are all sized to be 5 mm or less. In addition, the lithium ion secondary battery according to the aspect of the invention provides a far greater battery capacity than an MLCC also usable as a non-polar power source.

According to the above aspect (6) of the invention, even when a liquid electrolyte is employed, the lithium ion secondary battery is free from the danger associated with reverse charging. Thus, under a wider variety of conditions, the battery is safely chargeable.

According to the above aspect (8) of the invention, since the cost of using a small-sized battery is lower than ever before, reduction in size and cost of electronic devices are effectively achievable.

According to the above aspect (9) of the invention, since the lithium ion secondary battery is usable as a high-capacity capacitor device, circuits are more flexibly designed. For instance, by connecting the lithium ion secondary battery according to the aspect of the invention to between a power supplying AC/DC converter or DC/DC converter and a loading unit, the lithium ion secondary battery according to the aspect of the invention, which has a greater storage density, also serves as a smoothing condenser. Thus, the power is stably supplied to the loading unit with ripples suppressed, and the number of components is reducible.

### BRIEF DESCRIPTION OF THE DRAWINGS

FIG. 1 is a cross-sectional view schematically depicting a structure of a lithium ion secondary battery according to an exemplary embodiment of the invention.

FIGS. 2(a) to (d) are cross-sectional views depicting lithium ion secondary batteries according to other exemplary embodiments of the invention.

FIGS. 3(a) and (b) are cross-sectional views depicting lithium ion secondary batteries according to further exemplary embodiments of the invention.

FIG. 4 depicts graphs indicating an inter-terminal voltage exhibited, at the time of battery charging and discharging, by a battery in which LiMn₂O₄ and Li are used respectively for the positive electrode active substance and the negative electrode.

FIG. 5 depicts battery charging and discharging curves of a wet lithium ion secondary battery in which LiMn₂O₄ according to an example of the invention is used for both of its electrodes.

FIG. 6 depicts cycle characteristics of an all-solid lithium ion secondary battery according to an example of the invention.

FIG. 7 depicts battery charging and discharging curves of an all-solid lithium ion secondary battery according to an example of the invention.

FIG. 8 depicts a battery charging and discharging cycle curve of an all-solid lithium ion secondary battery according to an example of the invention.

FIG. 9 is a cross-sectional view depicting a known lithium ion secondary battery.

### DESCRIPTION OF EMBODIMENTS

In the following description, the best mode of the invention will be described.

The inventors have considered that, by using the same active substance for a positive electrode and a negative electrode, a battery will be made usable without attending to a distinction between terminal electrodes thereof, and thus that a polar examination of the battery will be consequently omissible, thereby simplifying a manufacturing process of the battery. Hereinafter, a secondary battery usable without attending to the distinction between its positive electrode and its negative electrode will be referred to as “non-polar secondary battery.”

An example for realizing a non-polar secondary battery is a multilayer ceramic capacitor (MLCC). According to a storage principle of the MLCC, the terminal electrodes of the MLCC do not have polarity, and a terminal electrode to be charged with a noble potential serves as the positive electrode while a terminal electrode to be charged with a base potential serves as the negative electrode. At the time of mounting the MLCC onto an electronic substrate, there is no need to attend to a mounting direction of the MLCC. However, since the storage of the MLCC is conducted by dielectric polarization, the MLCC has exhibited extremely low storage capacity per unit volume, as compared to electric capacitor devices that involve chemical reactions (e.g., lithium ion secondary battery).

The inventors have studied for realizing a non-polar battery with a lithium ion secondary battery. Specifically, concentrated studies have been made on materials for active substances useful for realizing a non-polar battery. As a result, the inventors have newly found that a composite oxide containing a spinel structured transition metal capable of changing its valence is useful as an active substance for a non-polar lithium ion secondary battery. Such composite oxide serves as a positive electrode active substance of the lithium ion secondary battery on one hand, and has in its spinel structure a site for absorbing a lithium ion on the other hand. A spinel structured transition metal composite oxide is capable of both discharging the lithium ion to the outside of the structure and absorbing the lithium ion into the structure, depending on the voltage applied. Thus, such compound concurrently has both of a function as a positive electrode active substance and a function as a negative electrode active substance. In this description, to “concurrently have the capabilities of both discharging the lithium ion and absorbing the lithium ion” means that, when the same active substance is used for both of the positive electrode and the negative electrode of the secondary battery, the active substance is capable of discharging the lithium ion and absorbing the lithium ion at the same time.

For instance, LiMn₂O₄, for which any one of the following reactions will possibly take place, is usable as the active substance for both electrodes of the non-polar battery, and thus LiMn₂O₄ concurrently has the capabilities of both discharging the lithium ion and absorbing the lithium ion:

Li₍₁₋ₓ₎Mn₂O₄←LiMn₂O₄ Reaction of discharging Li (battery charging);

Li₍₁₋ₓ₎Mn₂O₄→LiMn₂O₄ Reaction of absorbing Li (battery discharging);

LiMn₂O₄→Li_{(1+x)Mn}₂O₄ Reaction of absorbing Li (battery discharging); and

LiMn₂O₄←Li₍₁₊ₓ₎Mn₂O₄ Reaction of discharging Li (battery charging).

(0<x<1)

On the other hand, when LiCoO₂ is concerned, the following reactions will possibly take place:

Li₍₁₋ₓ₎LiCoO₂←LiCoO₂ Reaction of discharging Li (battery charging); and

Li₍₁₋ₓ₎LiCoO₂→LiCoO₂ Reaction of absorbing Li (battery discharging).

(0<x<1)

However, since none of the following reactions will possibly take pace, LiCoO₂ is not usable as the active substance for both electrodes of the non-polar battery, and thus LiCoO₂ does not concurrently have the capabilities of both discharging the lithium ion and absorbing the lithium ion:

LiCoO₂→Li₍₁₊ₓ₎LiCoO₂ Reaction of absorbing Li (battery discharging); and

LiCoO₂←Li₍₁₊ₓ₎LiCoO₂ Reaction of discharging Li (battery charging).

(0<x<1)

Further, when _{Li}₄Ti₅O₁₂ is concerned, the following reactions will possibly take place:

Li₄Ti₅O₁₂→Li₍₄₊ₓ₎Ti₅O₁₂ Reaction of absorbing Li (battery discharging); and

Li₄Ti₅O₁₂←Li₍₄₊ₓ₎Ti₅O₁₂ Reaction of discharging Li (battery charging).

(0<x<1)

However, since none of the following reactions will possibly take pace, Li₄Ti₅O₁₂ is not usable as the active substance for both electrodes of the non-polar battery, and thus Li₄Ti₅O₁₂ does not concurrently have the capabilities of both discharging the lithium ion and absorbing the lithium ion:

Li₍₄₋ₓ₎Ti₅O₁₂←Li₄Ti₅O₁₂ Reaction of discharging Li (battery charging); and

Li₍₄₋ₓ₎Ti₅O₁₂→Li₄Ti₅O₁₂ Reaction of absorbing Li (battery discharging).

(0<x<1)

In order for a substance to serve as the active substance having both of a function as a positive electrode active substance and a function as a negative electrode active substance, such substance is required to satisfy the conditions as follows: a.) its structure contain lithium; b.) its structure have a diffusion path of lithium ion; c.) its structure has a site for absorbing lithium ion; d.) the average valence of a non-precious metal element that forms the active substance be changeable both to a valence higher than a valence exhibited by the substance when the active substance is synthesized and to a valence lower than a valence exhibited by the substance when the active substance is synthesized; and e.) a suitable electron conductivity be exhibited.

Any active substances that satisfy the above conditions a.) to e.) are usable for the purpose of this invention. Examples of the spinel structured transition metal composite oxide are LiMn₂O₄ and LiV₂O₄. Further, without limitation thereto, an active substance structured such that some of Mn in LiMn₂O₄ is substituted by a metal other than Mn is also favorably usable as the active substance for the lithium ion secondary battery according to the aspect of the invention, because such active substance satisfies the above conditions a.) to e.). In addition, in order to obtain an all-solid battery, the active substance preferably exhibits sufficiently high heat resistance during a bulk baking process of the battery.

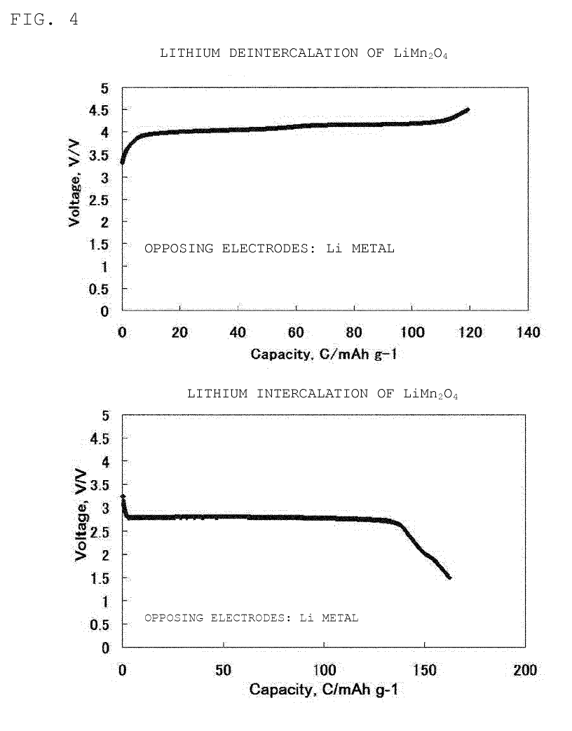

FIG. 4 depicts graphs indicating an inter-terminal voltage exhibited, at the time of battery charging and discharging, by a wet-cell battery in which LiMn₂O₄, Li and an organic electrolyte solution are used respectively as the positive electrode material, the negative electrode material and the electrolyte. LMO is an abbreviation of LiMn₂O₄. At the time of battery charging, the inter-terminal voltage is increased in accordance with the lapse of time, and saturated approximately at 4 V. On the other hand, at the time of battery discharging, the inter-terminal voltage initially exhibits approximately 2.8 V, and decreases in accordance with the lapse of time. Accordingly, LiMn₂O₄ exhibits a redox potential higher by approximately 4 V than a redox potential of Li at the time of deintercalation of Li ion, while exhibiting a redox potential higher by approximately 2.8 V than the redox potential of Li at the time of intercalation of Li ion. Specifically, when a battery in which LMO are concurrently used for both of the positive and negative electrodes is charged, lithium ion is deintercalated into the electrolyte from the LMO of the electrode positively (+) charged by a charger, and at the same time, the lithium ion having passed through the electrolyte is intercalated into the LOM of the electrode negatively (−) charged by the charger. Thus, the function as the battery is obtained.

(Structure of Battery)

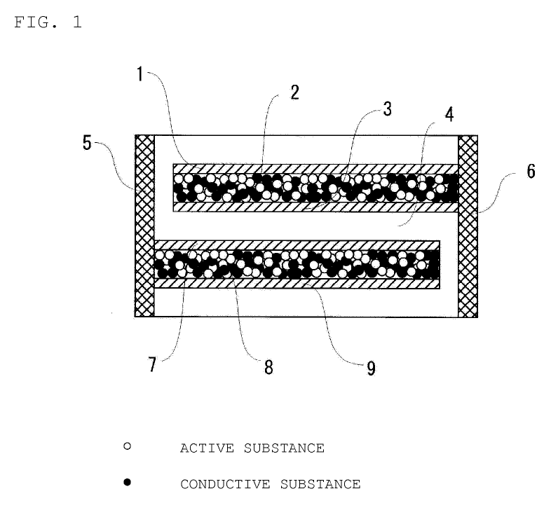

FIG. 1 is a cross-sectional view schematically depicting a structure of a lithium ion secondary battery according to an exemplary embodiment of the invention. The lithium ion secondary battery depicted in FIG. 1 includes: a first electrode layer that includes active substance layers 1 and 3 and a mixture layer 2 in which an active substance and a collector are mixed together; and a second electrode layer that includes active substance layers 7 and 9 and a mixture layer 8 in which an active substance and a collector are mixed together. The first electrode layer and the second electrode layer are alternately layered on each other while interposed by an electrolyte region 2. In both of the first electrode layer and the second electrode layer, the same active substance is contained. The above active substance concurrently has the capabilities of both discharging the lithium ion and absorbing the lithium ion, and also has a spinel crystal structure. The first electrode layer is electrically connected to a terminal electrode 5 at its right end, while the second electrode layer is electrically connected to a terminal electrode 4 at its left end. The electrode charged comparatively with a positive electric potential serves as the positive electrode at the time of battery discharging. For the electrolyte region 2, a solid electrolyte or a liquid electrolyte is usable.

Alternatively, the first electrode layer and the second electrode layer may have any one of the following structures:

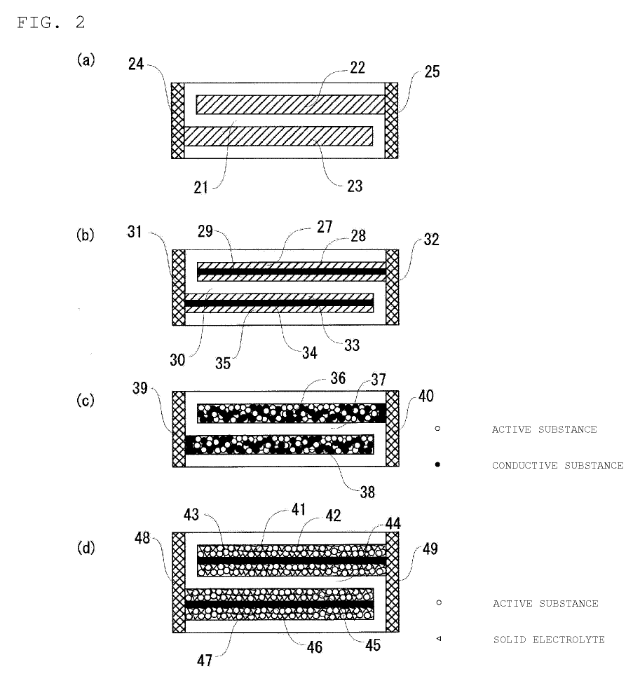

(1) Structure essentially composed of a layer formed from an active substance (see, FIG. 2(a));

In other words, according to this exemplary structure, the first electrode layer and the second electrode layer are respectively structured as single layers of active-substance formed from an active substance, and the single active-substance layers are not mixture layers in which an active substance is mixed with conductive substances and solid electrolytes.

(2) Structure in which a mixture layer containing a mixture of an active substance and a conductive substance is sandwiched by layers respectively formed from an active substance (see, FIG. 1);

In this structure, the mixture layer serves as a collector. The mixture layer may be structured such that conductive substance particles and active substance particles are simply mingled together (for example, the two substances may undergo a surface reaction or may be diffused), but the mixture layer is preferably structured such that the active substance is supported by a conductive matrix formed from the conductive substance. Both of the first electrode layer and the second electrode layer employ the same active substance, and likewise, the first electrode layer and the second electrode layer preferably employ the same conductive substance. In addition, in the first electrode layer and the second electrode layer, the active substance and the conductive substance are preferably mixed at the same mixing ratio. Further, in the first electrode layer and the second electrode layer, the aggregate of the active substance layers and the mixture layer is preferably substantially equally thickened.

(3) Structure essentially composed of a layer formed from a mixture of an active substance and a conductive substance (see, FIG. 2 (c));

The mixture layer may be structured such that mixture conductive substance particles and active substance particles are simply mingled together (for example, the two substances may undergo a surface reaction or may be diffused), but the mixture layer is preferably structured such that the active substance is supported by a conductive matrix formed from the conductive substance. Both of the first electrode layer and the second electrode layer employ the same active substance, and likewise, the first electrode layer and the second electrode layer preferably employ the same conductive substance. In addition, in the first electrode layer and the second electrode layer, the active substance and the conductive substance are preferably mixed at the same mixing ratio.

(4) Structure in which a conductive substance layer formed from a conductive substance is sandwiched by mixture layers respectively formed from mixtures of an active substance and a solid electrolyte (see, FIG. 2 (d)); or

The mixture layer may be structured such that solid electrolyte particles and active substance particles are simply mingled together (for example, the two substances may undergo a surface reaction or may be diffused), but the mixture layer is preferably structured such that the active substance is supported by a matrix formed from the solid electrolyte. Both of the first electrode layer and the second electrode layer employ the same active substance, and likewise, the first electrode layer and the second electrode layer preferably employ the same solid electrolyte. In addition, in the first electrode layer and the second electrode layer, the active substance and the solid electrolyte are preferably mixed at the same mixing ratio.

(5) Structure in which a conductive substance layer formed from a conductive substance is sandwiched by active substance layers (see, FIG. 2 (b)).

The first electrode layer and the second electrode layer employ the same active substance. Likewise, the first electrode layer and the second electrode layer preferably employ the same conductive substance.

If a laminate formed by layering the positive electrode layer and the negative electrode layer on each other with the interposition by the solid electrolyte layer is defined as one battery cell, FIG. 1 and 2(a) to (d) each depict a cross section of a battery in which a single battery cell is layered. However, the technique for the lithium ion secondary battery according to the aspect of the invention is not only applicable to the depicted battery in which the single battery cell is layered, but also applicable to a battery in which the suitable number of the battery cells are layered on one another. Thus, the lithium ion secondary battery is widely flexibly producible to conform to capacity or electric current specification required for the lithium ion secondary battery. For instance, a battery in which 2 to 500 battery cells are layered on one another is a practical battery.

In the following description, lithium ion secondary batteries according to other exemplary embodiments of the invention (see, FIG. 2) will be described in detail.

FIG. 2(b) depicts a cross section of a battery structured such that: a conductive substance layer (collector layer) 28 is formed in parallel to active substance layers 27 and 29; and a conductive substance layer (collector layer) 34 is formed in parallel to active substance layers 33 and 35, for reduction of internal resistance in the electrode layers. The collector layer is made from a highly conductive material such as metal paste.

FIG. 2 (c) depicts a cross section of a battery structured also to reduce the internal resistance in the electrode layers. In the laminate included in the battery, a mixture layer 36 formed from a mixture of an active substance and a conductive substance and another mixture layer 38 formed also from a mixture of an active substance and a conductive substance are alternately layered on each other while interposed by an electrolyte region 37.

FIG. 2 (d) depicts a cross section of a battery structured to provide a high capacity. In the laminate included in the battery, a first electrode layer and a second electrode layer are alternately layered on each other while interposed by an electrolyte region 44. The first electrode layer includes: a collector layer 42; and mixture layers 41 and 43 respectively formed from a mixture of an active substance and a solid electrolyte, while the second electrode layer includes: a collector layer 46; and mixture layers 45 and 47 respectively formed from a mixture of an active substance and a solid electrolyte. The substance usable in the electrolyte region 44 is preferably the same as the solid electrolyte used in the first electrode layer and the second electrode layer. Since, in the electrode layers, the active substance is in contact with the solid electrolyte at a greater area, the battery is able to provide a high capacity. While the collector layers 42 and 46 are disposed in parallel to the electrode layers, this arrangement is for reducing the internal resistance of the battery as in the battery depicted in FIG. 2(b). Thus, this arrangement is not a prerequisite for realizing the lithium ion secondary battery according to the aspect of the invention.

(Structure of Series Battery)

The batteries described with reference to FIGS. 1 and 2 are parallel batteries in which a plurality of battery cells is connected in parallel to provide the battery. However, the technical ideas disclosed herein are not only applicable to the parallel batteries but also applicable to series batteries and series parallel batteries, with which, needless to say, excellent effects are obtainable.

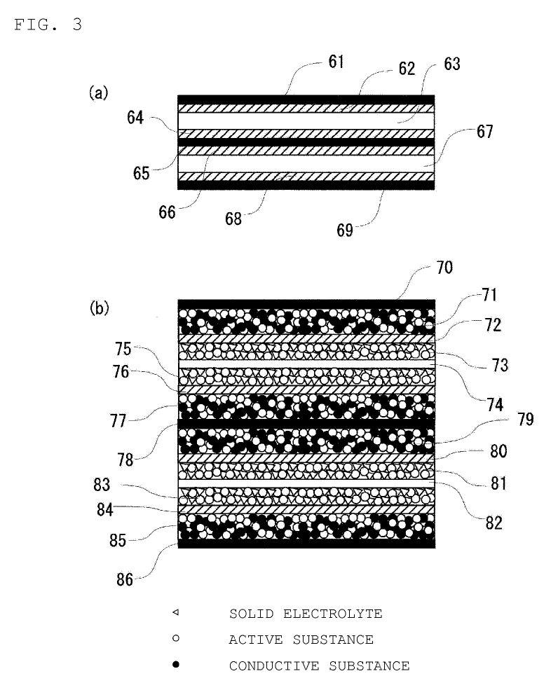

FIGS. 3(a) and (b) are cross-sectional views depicting a lithium ion secondary battery according to another exemplary embodiment of the invention. FIG. 3(a) depicts a battery in which two battery cells are connected in series. The battery depicted in FIG. 3(a) is structured such that a collector layer 69, an active substance layer 68, an electrolyte region 67, an active substance layer 66, a collector layer 65, an active substance layer 64, an electrolyte region 63, an active substance layer 62 and a collector layer 61 are sequentially layered on one another. By using the same active substance as the preferable active substance disclosed herein for each of the active substance layer, an excellent non-polar battery is producible. Unlike parallel batteries, series batteries require the battery cells to be partitioned from one another by lithium ion transfer inhibition layers, in order to inhibit the lithium ion from being transferred between different battery cells. Any layer that does not contain an active substance or an electrolyte may serve as such lithium ion transfer inhibition layer. In the battery depicted in FIG. 3(a), the collector layers serve as the lithium ion transfer inhibition layers.

FIG. 3(b) depicts another example of a series lithium ion secondary battery. This battery is structured to include three electrode layers. According to the structure of this battery, in order for the battery to provide a high capacity, layers abutting on the electrolyte regions are mixture layers respectively made from a mixture of an active substance and a solid electrolyte, and in order to reduce the internal resistance within the battery, layers abutting on the collector layers are mixture layers made from a mixture of an active substance and a conductive substance.

Needless to say, also in the series batteries exemplified in FIGS. 3(a) and (b), the substance for the electrolyte region may be a solid electrolyte or a liquid electrolyte.

(Definitions of Terms)

As described so far with reference to the attached drawings, the “electrode layer” herein is defined to mean any one of the following:

(1) an active substance layer formed only from an active substance;

(2) a mixture layer formed from a mixture of an active substance and a conductive substance;

(3) a mixture layer formed from a mixture of an active substance and a solid electrolyte; or

(4) a laminate in which a single one or a combination of the above layers (1) to (3) and a collector layer are layered on one another.

(Material of Battery)

(Material of Active Substance)

For use in the active substance employed in the electrode layers of the lithium ion secondary battery according to the aspect of the invention, materials that efficiently discharge and absorb lithium ion are preferable. Examples are spinel structured transition metal oxides or transition metal composite oxides. An active substance whose transition metal is capable of changing its valence is preferably usable as the active substance. Further, a spinel structured LiM₂O₄ (M is an element selected from the group consisting of Ti, V, Cr, Mn, Fe, Co, Ni and Mo or a combination of elements selected from the same group (an example of such combination is m=MnCo)) is preferably usable. Still further, a substance that has a spinel crystal structure containing at least Mn is preferably usable.

(Material of Conductive Substance)

For use in the conductive substance employed in the electrode layers of the lithium ion secondary battery according to the aspect of the invention, materials having high conductivity are preferable. For example, metals or alloys having high oxidation resistivity are preferable. The “metals or alloys having high oxidation resistivity” are metals or alloys that exhibit conductivity of 1×10¹ S/cm or more after baked under an air atmosphere. More specifically, preferable examples of such metal are silver, palladium, gold, platinum and aluminum. Preferable examples of such alloy are alloys made from at least two metals selected from the group consisting of silver, palladium, gold, platinum, copper and aluminum. For instance, AgPd is preferably usable. AgPd is preferably a mixture powder of Ag powder and Pd powder, or a powder of an AgPd alloy.

While each electrode may employ a different mixing ratio for mixing the active substance with the materials of the conductive substance for use in the electrode layer, each electrode preferably employs the equal mixing ratio so that shrinkage behaviors and properties at the time of bulk baking are unified for a non-polar battery.

(Material of Solid Electrolyte)

For use in the solid electrolyte employed in the solid electrolyte layers of the lithium ion secondary battery according to the aspect of the invention, materials having low electron conductivity and high lithium ion conductivity are preferable. In addition, inorganic materials bakeable at a high temperature under an air atmosphere are preferable. An example of such material is preferably at least one material selected from the group consisting of: oxides of lithium, lanthanum or titanium; oxides of lithium, lanthanum, tantalum, barium or titanium; polyanion oxides containing lithium but not containing multivalent transition element; polyanion oxides containing lithium, a representative element and at least one transition element; lithium silicophosphate (Li_{3.5}Si_{0.5}P_{0.5}O₄); titanium lithium phosphate (LiTi₂(PO₄)₂); germanium lithium phosphate (LiGe₂(PO₄)₃); Li₂O—SiO₂; Li₂O—V₂O₅—SiO₂; Li₂O—P₂O₅—B₂O₃; and Li₂O—GeO₂. In addition, the material for the solid electrolyte layer is preferably ceramic containing at least lithium, phosphorus and silicon. Further, the above materials may be doped with different elements, Li₂PO₄, LiPO₃, Li₄SiO₄, Li₂SiO₃, LiBO₂ or the like. The material for the solid electrolyte layer may be a crystalline, amorphous or glass material.

(Manufacturing Method of Battery)

The lithium ion secondary battery according to the aspect of the invention is preferably manufactured by sequentially conducting the following:

(1) Obtaining an active substance-mixed collector electrode paste, by dispersing a predetermined active substance and a conductive metal in a vehicle containing an organic binder, solvent, coupling agent and dispersant;

(2) Obtaining an active substance paste, by dispersing a predetermined active substance in a vehicle containing an organic binder, solvent, coupling agent and dispersant;

(3) Obtaining a slip of an inorganic solid electrolyte, by dispersing an inorganic solid electrolyte in a vehicle containing an organic binder, solvent, coupling agent and dispersant;

(4) Obtaining a thin-layered sheet of the inorganic solid electrolyte, by applying the slip of the inorganic solid electrolyte onto a substrate and drying the same;

(5) Printing the active substance paste and the collector electrode paste onto the sheet of the inorganic solid electrolyte and drying the same;

(6) Layering the printed sheets obtained from the above (5);

(7) Suitably cutting the laminate obtained from the above (6) and baking the same; and

(8) Attaching terminal electrodes to the laminates obtained from the above (7).

In the following description, a preferable exemplary embodiment of the manufacturing method for the lithium ion secondary battery according to the aspect of the invention will be described, but the manufacturing method for the lithium ion secondary battery according to the aspect of the invention is not limited to the manufacturing methods described below.

(Preparing Process of Active Substance Paste)

The active substance paste is prepared in the following manner. Powder of the predetermined active substance is ground into particles suitably for an all-solid secondary battery with use of a dry mill and a wet mill, and subsequently dispersed into an organic binder and solvent with use of a disperser such as a planetary mixer or a triple roll mill. In order to favorably disperse the active substance into the organic binder, a coupling agent or dispersant may be added thereto as needed.

The dispersing method applicable to the aspect of the invention is not limited to the above-described dispersing method, but may be any other method as long as: no cohesion of the active substance is present in the paste; and a high dispersion is realized to an extent that the printing to the solid electrolyte sheet is not obstructed. For a favorable printing, the paste used for the aspect of the invention is preferably added with a solvent as needed so that the viscosity thereof is adjusted. Further, to conform to the required capacities of the battery, the paste may be further added with a conductivity aiding material, a rheology modifier or the like as needed.

(Preparing Process of Active Substance-Mixed Collector Electrode Paste)

The active substance-mixed collector electrode paste is prepared in the following manner. Powder of the predetermined active substance is ground into particles suitably for an all-solid secondary battery with use of a dry mill and a wet mill, and subsequently mixed with metal powder for use in the collector electrode. Then, the obtained product is dispersed into an organic binder and solvent with use of a disperser such as a planetary mixer or a triple roll mill. In order to favorably disperse the active substance into the organic binder, a coupling agent or dispersant may be added thereto as needed. The dispersing method applicable to the aspect of the invention is not limited to the above-described dispersing method, but may be any other method as long as: no cohesion of the active substance is present in the paste; and a high dispersion is realized to an extent that the printing to the solid electrolyte sheet is not obstructed. For a favorable printing, the paste used for the aspect of the invention is preferably added with a solvent as needed so that the viscosity thereof is adjusted. Further, to conform to the required capacities of the battery, the paste may be further added with a conductivity aiding material, a rheology modifier or the like as needed.

(Preparing Process of Inorganic Solid Electrolyte Sheet)

The thin-layered sheet of the inorganic solid electrolyte is prepared in the following manner. Powder of the inorganic solid electrolyte is ground into particles suitably for an all-solid secondary battery with use of a dry mill and a wet mill, and subsequently mixed with an organic binder and solvent. Then, the obtained product is dispersed with use of a wet mill such as a pot mill or a bead mill, and the slip of the inorganic solid electrolyte is obtained. The obtained slip of the inorganic solid electrolyte is thinly applied onto a substrate such as a PET film by a method such as doctor blade, and subsequently dried so that the solvent is evaporated. Then, the thin-layered sheet of the inorganic solid electrolyte is obtained on the substrate. In order to favorably disperse the powder of the inorganic solid electrolyte into the organic binder, a coupling agent or dispersant may be added thereto as needed.

The dispersing method applicable to the aspect of the invention is not limited to the above-described dispersing method, but may be any other method as long as: no cohesion of the inorganic solid electrolyte powder is present either on the surfaces of or in the inside of the inorganic solid electrolyte sheet; and a high dispersion is realized to an extent that the printing to the solid electrolyte sheet is not obstructed.

(Printing Process of Active Substance Paste and Active Substance-Mixed Electrode Paste onto Inorganic Solid Electrolyte)

Onto the thus-obtained inorganic solid electrolyte sheet, the active substance paste, the active substance-mixed collector electrode paste and further the active substance paste are printed to be superposed thereon. Then, by drying the obtained product, the inorganic solid electrolyte sheet printed with the active substance is obtained. The printing of the active substance paste onto the inorganic solid electrolyte sheet may be conducted such that drying is performed every time the paste is applied, or such that drying is performed after the three layers of the active substance paste, the active substance mixed paste and the active substance paste have been printed. Examples of the printing method are screen printing or inkjet printing. When the printing is conducted by screen printing, the former printing and drying process is preferable. On the other hand, when the printing is conducted by ink jet printing, the latter printing and drying process is preferable. When the latter printing and drying process is applied, after the active substance paste is printed onto the inorganic solid electrolyte, the printing of the active substance-mixed collector electrode paste is initiated without drying the active substance paste. Thus, the printing interface of the active substance paste is more favorably jointed to the printing interface of the active substance-mixed collector electrode paste.

(Processing of Battery End Surface)

The printing end surface of the active substance paste and the printing end surface of the active substance-mixed collector electrode paste, or the printing end surface of the active substance-mixed collector electrode paste are/is printed on the inorganic solid electrolyte sheet so as to reach either end surface of the inorganic solid electrolyte sheet. Alternatively, the inorganic solid electrolyte sheet on which the active substance and the active substance-mixed collector paste are printed in a layered manner is peeled off from the substrate, and the obtained sheets are further layered and pressed. Then, by cutting the obtained laminate, a predetermined end surface is obtainable.

(Baking Process of Laminate)

The obtained laminate is baked into the targeted non-polar lithium ion secondary battery. The baking conditions are determined suitably in view of: the types of the organic binder, solvent, coupling agent and dispersant contained in the active substance paste, the active substance-mixed collector electrode paste and the slip of the inorganic solid electrolyte; the types of the active substance contained in the active substance paste; and the types of the metal used in the active substance-mixed collector electrode paste. Organic substances, if not resolved during the baking, will lead not only to a peeling of the laminate after the baking, but also to a short circuit in the battery due to the remaining carbon. In particular, when the baking is conducted under an atmosphere that contains no oxygen, in order to minimize the carbon remaining in the battery, the baking is preferably proceeded with by further introducing steam therein so that the oxidation of the organic substances is promoted.

(Addition of Flux)

In order to unify sintering behaviors of the active substances, the collector metals and the inorganic solid electrolyte in each layer of the laminate or to enable these substances to be sintered at a lower temperature, the active substance paste, the active substance-mixed collector electrode paste and the slip of the inorganic solid electrolyte may be added with a flux that promotes sintering. The flux may be added thereto by: preliminarily adding to the powder of the active substance or the material powder for synthesizing the inorganic solid electrolyte at the time of synthesizing the powder of the active substance or the inorganic solid electrolyte; or adding to the synthesized active substance or the inorganic solid electrolyte at the time of dispersing the synthesized active substance or the synthesized inorganic solid electrolyte into the organic binder, solvent or the like.

(Preparing Process of Terminal Electrodes)

The terminal electrodes are prepared, for instance, by: applying a thermoset conductive paste onto electrode end surfaces of the all-solid secondary battery obtained by baking the laminate green and solidifying the applied thermoset conductive paste; applying a bakeable paste containing a metal and sintering the paste through baking; plating the battery with a material; plating the battery with a material and then soldering; or applying a soldering paste and heating the paste. Preferably, the method of applying and solidifying the thermoset conductive paste is the simplest among the above preparing methods.

(Difference from Similar Known Techniques)

Patent Document 2 discloses an all-solid battery in which a substance containing polyanion is used for all of its active substances and solid electrolytes. Judging only from what is claimed in Patent Document 2, a combination of a positive electrode active substance and a negative electrode active substance that are made from the same material is disclosed. However, the battery disclosed in Patent Document 2 is intended merely for the objects of: increasing the output of the battery; extending the lifetime of the battery; enhancing the safety of the battery; and reducing the cost of the battery, and is not intended for the object of non-polarizing the battery. Actually, the examples of Patent Document 2 describes a battery in which different active substances were respectively used for the positive electrode and the negative electrode, i.e., a battery that is not usable as a non-polar battery. Accordingly, the lithium ion secondary battery according to the aspect of the invention (i.e., the lithium ion secondary battery in which the same active substance is used for both of the positive electrode and the negative electrode for the object of non-polarizing the battery) is not easily perceived from the description of Patent Document 2.

In addition, according to the compound containing polyanion disclosed in Patent Document 2 as the active substance material, the Si, P, S, Mo or B in the SiO₄, PO₄, SO₄, MoO₄, BO₄ or BO₃ for forming the polyanion exhibits a strong oxygen bonding strength, and thus electrons in the inorganic compounds are constrained to the bonding. Therefore, the electron conductivity exhibited by the active substance material of Patent Document 2 is lower than that exhibited by the active substance used in the lithium ion secondary battery according to the aspect of the invention (i.e., active substance such as spinel compounds not containing polyanion (e.g., LiMn₂O₄) or layered compounds (e.g., LiCoO₂ or LiCoₓM₍₁₋ₓ₎O₂)), and the internal resistivity may be increased in the battery of Patent Document 2. Further, the lithium diffusion path included in the structure of LiCoPO₄ and LiFePO₄ (i.e., the active substance material disclosed in Patent Document 2) is one dimensional diffusion, and thus requires the diffusing direction of the lithium to be designed based on the potential gradient. In contrast, the spinel structured LiMn₂O₄ (i.e., the active substance material used in the aspect of the invention) does not require the Li diffusing direction to be taken into account, because the lithium ion has a three dimensional diffusion structure. Therefore, the lithium ion secondary battery according to the aspect of the invention is excellent in that the structuring and designing of the battery is highly flexible, and that simplification of the manufacturing process therefor is realizable.

Patent Document 3 discloses a wet battery in which: a liquid electrolyte is used; and the same active substance is used for both of the electrodes. According to Patent Document 3, by using the same active substance for both of the electrodes and making the difference in potential between the active substances zero at the time of preparing the battery, electrolysis of the electrolyte solution is avoided. With this arrangement, danger of explosion and ignition caused by gas generated from the electrolysis of the electrolyte solution is reduced. The battery disclosed in Patent Document 3 is intended for the object of enhancing the preservation safety of the battery, and is not intended for the object of non-polarizing the battery, either. Further, Patent Document 3 provides no disclosure with respect to the active substance material suitable for a non-polar battery having a high capacity. Like the active substances disclosed in Patent Document 2, the active substances disclosed in Patent Document 3 are also compounds containing polyanion. As described above, such compound is inferior to the active substances according to the aspect of the invention in terms of the low electron conductivity and limitations in the lithium diffusion direction, and thus not suitable for producing a battery having a high capacity. Examples of Patent Document 3 describes a coin-type cell having a diameter of 10 mm and more in which the positive and negative electrodes are asymmetrically structured. Accordingly, the lithium ion secondary battery according to the aspect of the invention (i.e., the lithium ion secondary battery in which the same active substance used for both of the positive electrode and the negative electrode for the object of non-polarizing the battery) is not easily perceived from the description of Patent Document 3.

Patent Document 4 discloses a non-polar lithium ion secondary battery in which the active substances for both electrodes of the battery contain Li₂FeS₂. Li₂FeS₂, i.e., the active substance disclosed in Patent Document 4, also concurrently has the capabilities of both discharging the lithium ion and absorbing the lithium ion, but Li₂FeS₂ is a problematic substance when applied to the battery, unlike the composite oxide containing a spinel structured transition metal capable of changing its valence (i.e., one of the active substances according to the aspect of the invention). For example, Li₂FeS₂ is not able to be synthesized in an air atmosphere because the material therefor is highly reactive as described in paragraph of Patent Document 4, and thus Li₂FeS₂ is synthesized by vacuum heating. Therefore, the manufacturing apparatus therefor requires a vacuum unit, which leads to an increase in the manufacturing cost. Likewise, laminates of the substance are not able to be subjected to bulk baking under an air atmosphere. In addition, since Li₂FeS₂ is a sulfide, Li₂FeS₂ will generate hydrogen sulfide by reacting with moisture contained in the air atmosphere. Accordingly, as depicted in FIG. 1 of Patent Document 4, the battery of Patent Document 4 requires to be encapsulated in an outer can provided to surround the battery, which makes difficult the downsizing of the battery. As described in paragraph [0051] of Patent Document 4, the battery of Patent Document 4 exhibits a low output characteristic, and thus its usability is limited. In contrast, the composite oxide containing a spinel structured transition metal capable of changing its valence, i.e., one of the active substances according to the aspect of the invention, enables the active substance to be synthesized under an air atmosphere, and the laminates in the battery to be baked in bulk under an air atmosphere, which leads to a reduction in the manufacturing cost. In addition, the battery is manufacturable through a known manufacturing process applied to laminate ceramic condensers or the like. Further, the output voltage of the battery, which is exemplarily approximately 1.2 V when LiMn₂O₄ is used, is sufficiently high. Therefore, the battery according to the aspect of the invention is applicable to wide variety of application fields.

(Application to Fields Other Than Power Source)

The lithium ion secondary battery according to the aspect of the invention is applicable to fields other than power sources. One of the backgrounds thereof is an increase in wiring resistance of a power source due to reduction in wiring width entailed by reduction in size and weight of electronic devices. For instance, when power consumption by CPU is increased in a laptop PC while the wiring resistance of a power source is high, the voltage of the power source supplied to the CPU may fall below the minimum drive voltage, and problems such as signal processing errors and outages may occur. Accordingly, by disposing a capacitor device including a smoothing condenser between a power supply unit (e.g., AC/DC converter or DC/DC converter) and a loading unit (e.g., CPU) to suppress ripples of the power source line, a predetermined power is constantly supplied to the loading unit even when the voltage of the power source is temporarily reduced. However, the capacitor device such as an aluminum electrolytic capacitor and a tantalum electrolytic capacitor utilizes a storage principle based on dielectric polarization, and thus suffers from a drawback that its storage density is small. In addition, these capacitor devices use an electrolyte solution, which makes it difficult to mount the devices in the vicinity of components on a substrate by solder reflow.

In contrast, the lithium ion secondary battery according to the aspect of the invention is mountable in the vicinity of the components (loading unit) on the substrate. Specifically, when the lithium ion secondary battery according to the aspect of the invention is mounted in the immediate vicinity of a component that consumes a greater power in order to use the battery as a capacitor device, the lithium ion secondary battery is able to provide the functions as the capacitor device to the maximum degree. Further, the lithium ion secondary battery according to the aspect of the invention is a prominently small non-polar battery, and thus easily mountable onto the mounting substrate. In particular, the lithium ion secondary battery using the inorganic solid electrolyte, which exhibits high heat resistance, is mountable by solder reflow. The lithium ion secondary battery, which utilizes a storage principle based on the transfer of lithium ion between the electrodes, provides a great storage density. Accordingly, the non-polar lithium ion secondary battery, when used as the capacitor device, serves as an excellent smoothing condenser and/or an excellent backup power supply, and thus is capable of supplying stable power to the loading unit. Also, the lithium ion secondary battery according to the aspect of the invention provides further advantageous effects such as enhancement of flexibility in designing the circuit and the mounting substrate and reduction in the number of the components.

### EXAMPLES

### Example 1

In the following description, the aspect of the invention is described in further detail with reference to Examples, but the invention is not limited to these Examples. Unless otherwise specified, the “part” indicated below means part by weight.

(Preparation of Active Substance)

LiMn₂O₄ prepared in the following method was used as the active substance.

Li₂CO₃ and MnCO₃, which were used as the starting materials, were weighted to be balanced at a mass ratio of 1 to 4. Then, with water used as the solvent, the Li₂CO₃ and MnCO₃ experienced 16-hour wet blending by a ball mill, and subsequently subjected to dehydration drying. The obtained powder was calcinated at 800° C. for two hours in the air. The calcinated product were roughly ground, and with water used as the solvent, subjected to 16-hour wet blending by a ball mill . Subsequently, the product was subjected to dehydration drying, and active substance powder was obtained. The average particle diameter of the powder was 0.30 μm. With use of an X-ray diffractometer, the prepared powder was confirmed to have the composition of LiMn₂O₄.

(Preparation of Active Substance Paste)

For preparation of an active substance paste, 100 parts of the active substance powder were added with 15 parts of ethyl cellulose (i.e., binder) and 65 parts of dihydroterpineol (i.e., solvent). By kneading and dispersing the obtained product with use of a three roll, an active substance paste was prepared.

(Preparing Inorganic Solid Electrolyte Sheet)

Li_{3.5}Si_{0.5}P_{0.5}O₄ prepared in the following method was used as the inorganic solid electrolyte.

Li₂CO₃, SiO₂ and commercially-available Li₃PO₄, which were used as the starting materials, were weighted to be balanced at a mass ratio of 2 to 1 to 1. Then, with water used as the solvent, the Li₂CO₃, SiO₂ and Li₃PO₄ experienced 16-hour wet blending by a ball mill, and subsequently subjected to dehydration drying. The obtained powder was calcinated at 950° C. for two hours in the air. The calcinated product were roughly ground, and with water used as the solvent, subjected to 16-hour wet blending by a ball mill. Subsequently, the product was subjected to dehydration drying, and powder of ion conductive inorganic substance was obtained. The average particle diameter of the powder was 0.49 μm. With use of an X-ray diffractometer, the prepared powder was confirmed to have the composition of Li_{3.5}Si_{0.5}P_{0.5}O₄.

Subsequently, 100 parts of the powder were added with 100 parts of ethanol and 200 parts of toluene and subjected to wet blending by a ball mill. Then, by further adding and mixing the product with 16 parts of a polyvinyl butyral binder and 4.8 parts of benzyl butyl phthalate, an ion conductive inorganic substance paste was prepared. With a PET film used as the substrate, the ion conductive inorganic substance paste was formed into a sheet by doctor blade, and a 9-μm thick ion conductive inorganic substance sheet was obtained.

(Preparation of Active Substance-Mixed Collector Paste)

For obtaining a collector, 90 parts of Ag/Pd (weight ratio of 70 to 30) and 10 parts of LiMn₂O₄ were mixed together, and then added with 10 parts of ethyl cellulose (i.e., binder) and 50 parts of dihydroterpineol (i.e., solvent) . Thereafter, by kneading and dispersing the obtained product with use of a three roll, a collector paste was prepared. The Ag/Pd (weight ratio of 70 to 30) was mixture of Ag powder (average particle diameter of 0.3 μm) and Pd powder (average particle diameter of 1.0 μm).

(Preparation of Terminal Electrode Paste)

By kneading and dispersing silver fine powder, an epoxy resin and a solvent with use of a three roll, a thermoset conductive paste was prepared.

With use of these pastes, an all-solid secondary battery was prepared in the following manner.

(Preparation of Active Substance Unit)

The active substance paste was printed onto the above ion conductive inorganic substance sheet by screen printing to be 7-μm thick. Then, the printed active substance paste was dried at 80 to 100° C. for five to ten minutes, and the active substance-mixed collector paste was printed thereon by screen printing to be 5-μm thick. Thereafter, the printed collector paste was dried at 80 to 100° C. for five to ten minutes, and the active substance paste was further printed again thereon by screen printing to be 7-μm thick. The printed active substance paste was dried at 80 to 100° C. for five to ten minutes, and subsequently the PET film was peeled therefrom. In the above manner, a sheet of an active substance unit, which was structured such that the active substance paste, the active substance-mixed collector paste and the active substance paste were sequentially printed and dried on the inorganic solid electrolyte sheet, was obtained.

(Preparation of Laminate)

Two sheets of the active substance unit were layered on each other while interposed by the inorganic solid electrolyte. At this time, the active substance units were layered on each other in such a misaligned manner that: the layer of the active substance-mixed collector paste contained in a first active substance unit extended to only a first end surface; and the layer of the active substance-mixed collector paste contained in a second active substance unit extended to only a second end surface. On each surface of the layered units, the inorganic solid electrolyte sheet was layered to be 500-micron thick, and subsequently subjected to forming at a temperature of 80° C. under a pressure of 1000 kgf /cm² [98 Mpa]. Thereafter, the product was cut into laminar blocks. Then, the laminar blocks were baked in bulk to obtain laminate. The bulk baking was conducted in the air while raising a temperature up to 1000° C. at a temperature rise rate of 200° C./hour and maintaining the temperature for two hours. The baked products were naturally cooled down.

In outer appearance, the battery after the bulk baking was sized to be 3.7 mm×3.2 mm×0.35 mm.

(Preparing Process of Terminal Electrodes)

The terminal electrode paste was applied onto an end surface of the laminate, and subjected to thermal hardening for 30 minutes at 150° C. to obtain a pair of terminal electrodes. In this manner, an all-solid lithium ion secondary battery was obtained.

### Example 2

An all-solid secondary battery according to Example 2 was prepared in a manufacturing process similar to that of Example 1, except that the sheet of the active substance unit was prepared by applying only the active substance-mixed collector paste onto the inorganic solid electrolyte sheet and drying the same. In the prepared battery, the active substance-mixed collector electrode was 7-μm thick.

In outer appearance, the battery after the bulk baking was sized to be 3.7 mm×3.2 mm×0.35 mm.

(Evaluation of Battery Characteristics)

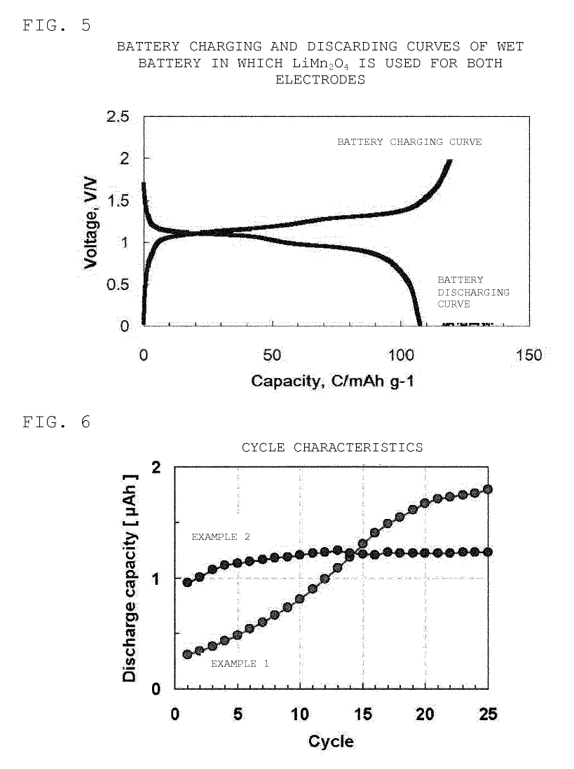

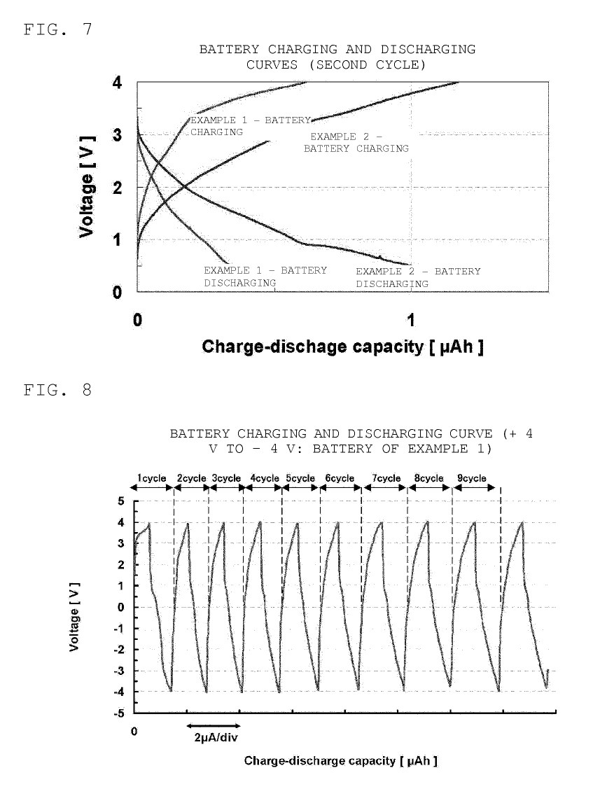

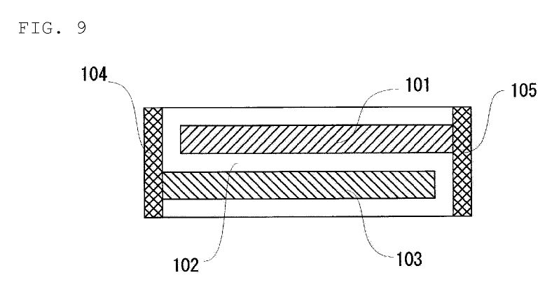

Each terminal electrode was attached with a lead wire, and a battery charging and discharging examination was conducted in a repeated manner. Measurement conditions were set such that: current was 0.1 μA for both battery charging and discharging; cutoff voltage was 4.5 V for battery charging and 0.5 V for battery discharging; and continuation of the battery charging and discharging was within 300 minutes. The results are indicated in FIG. 7. According to the results, in both of Examples 1 and 2, the non-polar lithium ion secondary battery prepared according to the aspect of the invention was observed to function as a battery. FIG. 6 further indicates cycle characteristics of the non-polar batteries prepared in Examples 1 and 2. According to this graph, while both of Examples 1 and 2 were observed workable as a repeatedly chargeable secondary battery, Example 1 was apt to increase its battery discharging capacity as the battery charging and discharging were repeated, but in contrast, the battery discharging capacity of Example 2 became constant after approximately ten cycles of the battery charging and discharging. Although the causes thereof are not clearly known, the same phenomenon can be observed even when the concerned non-polar batteries are structured the same, if the baking conditions therefor are different. Therefore, the causes are inferred to be attributed to a difference in a state of the joint interface at the time of bulk baking.

(Observation of Non-polar Performance)

FIG. 8 indicates a battery charging and discharging curve exhibited by the battery of Example 1, when the battery of Example 1 was: initially charged from the 0 V up to 4 V of the battery charging voltage; then discharged down to the 0 V; subsequently reversely charged down to −4 V; and thereafter reversely discharged up to the 0 V in order to confirm that it is non-polar. According to this graph, the battery is able to sequentially repeat a battery charging, battery discharging, a reverse battery charging and a reverse battery discharging. Accordingly, the all-solid battery according to the aspect of the invention is a non-polar battery, and capable of battery charging and discharging.

### Example 3

The active substance material that the inventors have found applicable to the active substance of a non-polar battery has turned out to be not only usable in an all-solid secondary battery, but also usable in a wet secondary battery. When used in such wet secondary battery, excellent battery characteristics were exhibited. Description will be made below with respect to the manufacturing method, evaluating method and evaluating results of a wet battery.

The above active substance, ketjen black and poly vinylidene difluoride were mixed at a weight ratio of 70:25:5, and added with N-methylpyrrolidone to obtain a slip of the active substance. Thereafter, the product was uniformly applied onto stainless foil by doctor blade and dried. Products obtained by punching the active substance-applied stainless sheet with a 14-mmφ punch (hereinafter referred to as “disk sheet electrode”) was subjected to vacuum deaeration drying at 120° C. for 24 hours. Then, the weight of the disk sheet electrode was precisely measured in a glove box whose dew point was −65° C. or less. Also, a stainless-foil disk sheet obtained by punching only the stainless sheet to have a diameter of 14 mmφ was separately precisely measured. Based on a difference in the measurement result between the above disk sheet electrode and the stainless-foil disk sheet, the weight of the active substance applied on the disk sheet electrode was accurately calculated. With the thus-obtained disk sheet electrode used for both battery electrodes, a wet battery was prepared. The battery included a porous polypropylene separator, a nonwoven electrolyte holder sheet and an organic electrolyte in which lithium ion was dissolved (i.e., an electrolyte prepared by dissolving 1 mol/L of LiPF6 in an organic solvent formulated as EC : DEC=1:1 vol).

A battery charging and discharging examination was conducted on the prepared battery at a battery charging and discharging rate of 0.1 C, and the battery charging and discharging capacity was measured.

FIG. 5 indicates a battery charging and discharging curve exhibited by the non-polar wet battery prepared in Example 3. The wet battery using the organic electrolyte solution was also a non-polar battery because the same spinel structured LiMn₂O₄ was used for both the electrodes. LiMn₂O_{4 applied} with a noble voltage by a battery charging and discharging measurement system caused a lithium deintercalation reaction while LiMn₂O₄ applied with a base voltage caused an intercalation reaction, and the battery was observed to function as a battery like in Examples 1 and 2.

A liquid electrolyte lithium ion secondary battery according to a known technique, in which different active substances have been used respectively for its positive electrode and its negative electrode, has been in danger of generating heat or getting damaged if reversely charged. However, the lithium ion secondary battery according to the aspect of the invention, in which the same active substance is used for its positive electrode and its negative electrode, is structured such that the active substances and collectors of the positive electrode and the negative electrode are formed to be symmetric to each other with respect to the electrolyte interposed between the positive electrode and the negative electrode. Thus, even when a liquid electrolyte is employed therein, the lithium ion secondary battery according to the aspect of the invention has been observed to be free from the above danger associated with the reverse battery charging.

### INDUSTRIAL APPLICABILITY

As described in detail above, according to the aspect of the invention, the manufacturing process and mounting process of the lithium ion secondary battery are simplified, which makes a great contribution to the fields of electronics.

### DESCRIPTION OF REFERENCE SIGNS

1, 3 active substance layer in first electrode layer

2 mixture layer mixed with active substance and collector in first electrode layer

4 electrolyte region

5 second terminal electrode

6 first terminal electrode

7, 9 active substance layer in second electrode layer

8 mixture layer mixed with active substance and collector in second electrode layer

21, 30, 37, 44 electrolyte region

22, 27, 29 active substance layer in first electrode layer

23, 33, 35 active substance layer in second electrode layer

24, 31, 39, 48 second terminal electrode

25, 32, 40, 49 first terminal electrode

28, 34, 42, 46 collector layer

36 mixture layer mixed with active substance and collector in first electrode layer

38 mixture layer mixed with active substance and collector in second electrode layer

41, 43 mixture layer mixed with active substance and solid electrolyte in first electrode layer

45, 47 mixture layer mixed with active substance and solid electrolyte in second electrode layer

61, 65, 69 collector layer

62, 64, 66, 68 active substance layer

63, 67 electrolyte region

70, 78, 86 collector layer

71, 77, 79, 85 mixture layer mixed with active substance and collector

72, 76, 80, 84 active substance layer

73, 75, 81, 83 mixture layer mixed with active substance and solid electrolyte

74, 82 electrolyte region

101 positive electrode layer

102 solid electrolyte layer

103 negative electrode layer

104, 105 terminal electrode

1. A lithium ion secondary battery, comprising:
a first electrode layer; and
a second electrode layer, wherein:
the first electrode layer and the second electrode layer are alternately layered on each other while interposed by an electrolyte region;
the first electrode layer and the second electrode layer are formed to contain the same active substance; and
the active substance concurrently has capabilities of both discharging lithium ion and absorbing lithium ion, the active substance having a spinel crystal structure.

2. The lithium ion secondary battery according to claim 1, wherein: the active substance is a transition metal composite oxide; and a transition metal in the transition metal composite oxide is adapted to change a valence.

3. The lithium ion secondary battery according to claim 1, wherein the active substance is a substance containing at least Mn.

4. The lithium ion secondary battery according to claim 1, wherein the active substance is LiMn₂O₄ or LiV₂O₄.

5. The lithium ion secondary battery according to claim 1, wherein a substance forming the electrolyte region is an inorganic solid electrolyte.

6. The lithium ion secondary battery according to claim 5, wherein the substance forming the electrolyte region is a ceramic containing at least lithium, phosphorus and silicon.

7. The lithium ion secondary battery according to claim 1, the lithium ion secondary battery being provided by baking a laminate in which the first electrode layer and the second electrode layer are layered on each other while interposed by the electrolyte region.

8. The lithium ion secondary battery according to claim 1, wherein a substance forming the electrolyte region is a liquid electrolyte.

9. The lithium ion secondary battery according to claim 1, the lithium ion secondary battery being a series or series parallel battery in which a conductive layer is disposed between abutting battery cells.

10. An electronic device, comprising: a power source, the power source being the lithium ion secondary battery according to claim 1.

11. An electronic device, comprising: a capacitor device, the capacitor device being the lithium ion secondary battery according to claim 1.

12. The lithium ion secondary battery according to claim 2, wherein the active substance is a substance containing at least Mn.

13. The lithium ion secondary battery according to claim 2, wherein the active substance is LiMn₂O₄ or LiV₂O₄.

14. The lithium ion secondary battery according to claim 3, wherein the active substance is LiMn₂O₄ or LiV₂O₄.

15. The lithium ion secondary battery according to claim 2, wherein a substance forming the electrolyte region is an inorganic solid electrolyte.

16. The lithium ion secondary battery according to claim 3, wherein a substance forming the electrolyte region is an inorganic solid electrolyte.

17. The lithium ion secondary battery according to claim 4, wherein a substance forming the electrolyte region is an inorganic solid electrolyte.

18. The lithium ion secondary battery according to claim 2, the lithium ion secondary battery being provided by baking a laminate in which the first electrode layer and the second electrode layer are layered on each other while interposed by the electrolyte region.

19. The lithium ion secondary battery according to claim 3, the lithium ion secondary battery being provided by baking a laminate in which the first electrode layer and the second electrode layer are layered on each other while interposed by the electrolyte region.

20. The lithium ion secondary battery according to claim 4, the lithium ion secondary battery being provided by baking a laminate in which the first electrode layer and the second electrode layer are layered on each other while interposed by the electrolyte region.
